(19) United States
(12) Patent Application Publication
(10) Pub. No.: US 2017/0237721 A1
(43) Pub. Date: Aug. 17, 2017

(54) DEEP PACKET INSPECTION (DPI) AT AN ENDPOINT

(71) Applicant: Seven Networks, LLC, Marshall, TX (US)

(72) Inventor: Ari Backholm, Marshall, TX (US)

(21) Appl. No.: 15/584,211

(22) Filed: May 2, 2017

Related U.S. Application Data
(63) Continuation of application No. PCT/US15/58673, filed on Nov. 2, 2015.
(60) Provisional application No. 62/074,250, filed on Nov. 3, 2014.

(51) Int. Cl. H04L 29/06; H04L 29/08; H04L 12/26

(52) U.S. Cl. CPC H04L 63/0485; H04L 43/022; H04L 63/0236; H04L 69/329; H04L 63/123; H04L 43/028; H04L 69/22; H04L 47/2441

(57) ABSTRACT

The subject matter described herein includes methods, systems, and computer program products for performing deep packet inspection at an endpoint. According to one method, a data portion of a data packet is examined at an inspection point located at an endpoint or mobile terminal of a communications network. A user profile associated with the endpoint or mobile terminal is provided that defines one or more actions or criteria to be applied to the data packet. An action related to the data packet is performed based on the examined data portion and the user profile.

### CROSS REFERENCE TO RELATED APPLICATION

This application is a continuation of International Patent Application Serial No. PCT/US2015/058673, filed 2 Nov. 2015, which claims the benefit of and priority to U.S. Provisional Patent Application No. 62/074,250 entitled “Deep Packet Inspection (DPI) at an Endpoint,” which was filed on Nov. 3, 2014, the contents of which are incorporated by reference herein in their entireties.

### BACKGROUND

Field of the Invention

The present invention relates to deep packet inspection (DPI), and more specifically, to performing deep packet inspection at an endpoint, such as a mobile communications terminal.

Description of Related Art

Traditionally, deep packet inspection of network traffic is managed at a network component such as a router or switch. In order to provide a comprehensive view of a user's activities as defined by the data packets sent and received from the user's endpoint (e.g., a smartphone), multiple network probes are installed to cover each network flow.

One disadvantage, however, to collecting/monitoring packets using probes located throughout an network operator's network is that some network flows associated with a user may not be in control of the same network operator. For example, a first network flow may be a Wi-Fi network flow and a second network flow may be a cellular network flow, each associated with the same endpoint. If network probes are installed in a Wi-Fi network and not installed in a cellular network, blind spots in the coverage of the user's activities may result.

Another disadvantage associated with conventional DPI is that some functions, such as user identification and performing user-specific actions, may require large amounts of processing and signaling overhead. For example, additional signaling between network components may be required in order to determine a user associated with each observed TCP/IP socket or to look up and maintain information about the user. A related disadvantage of conventional DPI includes the large amount of signaling associated with propagating, updating, and maintaining changes to user profiles. For example, propagating changes in user profiles or rules for DPI-based actions typically involve large amounts of signaling because the rules are propagated to each of the probes in the network.

Accordingly, a need exists for performing deep packet inspection which provides full coverage of a user's activities while minimizing associated signaling and processing overhead.

### BRIEF SUMMARY

According to one embodiment of the present invention, a method for performing DPI at an endpoint includes examining a data portion of a data packet at an inspection point located at an endpoint or mobile terminal of a communications network. A user profile associated with the endpoint or mobile terminal is provided that defines one or more actions or criteria to be applied to the data packet. An action related to the data packet is performed based on the examined data portion and the user profile.

A system includes an endpoint or mobile terminal of a communications network and, optionally, a server. The endpoint includes a user profile module and a deep packet inspection module. The user profile module is configured to maintain a user profile associated with the endpoint or mobile terminal that defines one or more actions or criteria to be applied to a data packet. The deep packet inspection module is configured to examine a data portion of the data packet and to perform an action related to the data packet based on the examined data portion and the user profile.

### BRIEF DESCRIPTION OF THE SEVERAL VIEWS OF THE DRAWINGS

FIG. 1 is a functional block diagram of an exemplary communications network suitable for performing DPI at an endpoint according to an embodiment of the subject matter described herein.

FIG. 2 is a table and bar chart showing exemplary HTTP latency data when performing DPI at an endpoint according to an embodiment of the subject matter described herein.

FIG. 3 is a table and bar chart showing exemplary HTTP latency comparison data between proxies and CDNs based on proxy IP address when performing DPI at an endpoint according to an embodiment of the subject matter described herein.

FIG. 4 is a table and bar chart showing exemplary HTTP latency comparison data for content owners based on original destination and proxy IP address when performing DPI at an endpoint according to an embodiment of the subject matter described herein.

FIG. 5 is a table and bar chart showing exemplary HTTP latency comparison data for different proxy servers when performing DPI at an endpoint according to an embodiment of the subject matter described herein.

FIG. 6 is a table and bar chart showing exemplary HTTP latency comparison data for different server types based on the Server HTTP header and proxy IP address when performing DPI at an endpoint according to an embodiment of the subject matter described herein.

FIG. 7 is a table and bar chart showing exemplary HTTP latency comparison data for different applications when performing DPI at an endpoint according to an embodiment of the subject matter described herein.

FIG. 8 is a table and bar chart showing exemplary latency comparison data between HTTP and HTTPS for IPv4 when performing DPI at an endpoint according to an embodiment of the subject matter described herein.

FIG. 9 is a table and bar chart showing exemplary HTTP latency comparison data for different content types when performing DPI at an endpoint according to an embodiment of the subject matter described herein.

FIG. 10 is a table and bar chart showing exemplary HTTP latency comparison data for different carriers, network technologies, and cell IDs when performing DPI at an endpoint according to an embodiment of the subject matter described herein.

FIG. 11 is a table, bar chart, and map showing exemplary HTTP latency comparison data at a first level of granularity for proxies and CDNs in a single cell when performing DPI at an endpoint according to an embodiment of the subject matter described herein.

FIG. 12 is a table and bar chart showing exemplary HTTP latency comparison data at a second level of granularity for content owners in a single cell when performing DPI at an endpoint according to an embodiment of the subject matter described herein.

FIG. 13 is a table showing exemplary HTTP latency comparison data at a third level of granularity for content in a single cell when performing DPI at an endpoint according to an embodiment of the subject matter described herein.

FIG. 14 is a table and bar chart showing exemplary HTTP throughput data for HTTP downlink throughput per proxy/CDN when performing DPI at an endpoint according to an embodiment of the subject matter described herein.

FIG. 15 is a table and bar chart showing exemplary DNS response time data per carrier, network, and cell ID when performing DPI at an endpoint according to an embodiment of the subject matter described herein.

FIG. 16 is a table and bar chart showing exemplary SSL handshake duration data per proxy/CDN when performing DPI at an endpoint according to an embodiment of the subject matter described herein.

FIG. 17 is a table and bar chart showing exemplary application timeouts data per application when performing DPI at an endpoint according to an embodiment of the subject matter described herein.

### DETAILED DESCRIPTION

The subject matter described herein includes methods and systems for performing deep packet inspection at an endpoint, such as a mobile terminal. In contrast to conventional configurations which perform DPI at switches, routers, and other core network equipment, the present disclosure performs DPI-based analytics and reporting at the endpoint/user device.

For example, an endpoint or mobile terminal of a communications network may include a user profile module configured to maintain provide a user profile that defines one or more actions or criteria to be applied to a data packet. A deep packet inspection module can be configured to examine a data portion of the data packet and to perform an action related to the data packet based on the examined data portion and the user profile.

As will be described herein, performing DPI at the endpoint rather than at a network router or switch has several advantages over the latter approach. By capturing data at the only point in the network through which all of the user's data goes through (i.e., the endpoint), full coverage of the user's actions can be provided. Additionally, when DPI software code is executed in the endpoint device, the user (or the device) can easily be explicitly identified. Finally, signaling and processing overhead associated with performing DPI is reduced because user profile changes need only to be propagated to one location (i.e., the endpoint) rather than to multiple locations, as is the case in conventional configurations. Thus, the present disclosure overcomes the shortcomings associated with conventional DPI while providing DPI-based actions, management, and reporting desired by network operators.

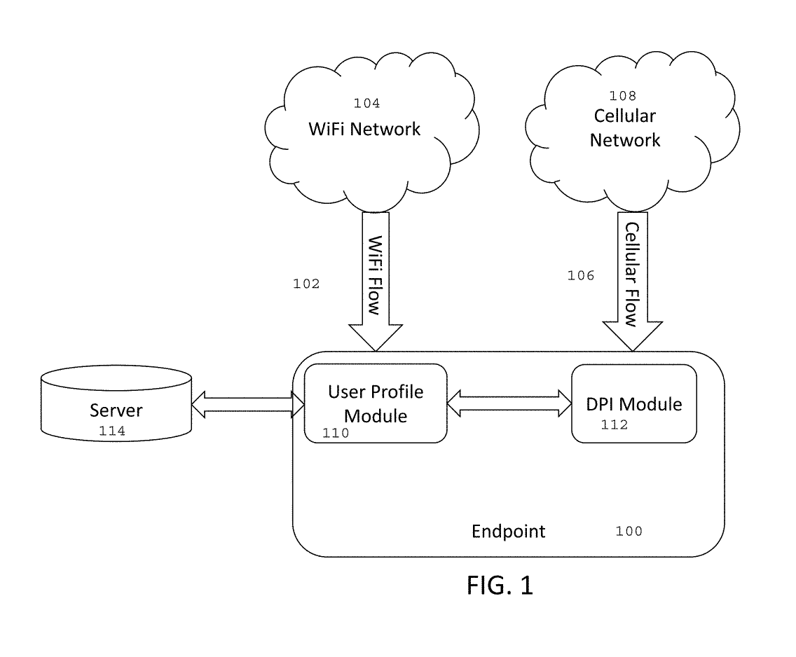

FIG. 1 is a functional block diagram of an exemplary communications network suitable for performing DPI at an endpoint according to an embodiment of the subject matter described herein. With reference now to FIG. 1, a network diagram illustrating an example embodiment for performing DPI at an endpoint is shown where the endpoint 100 may be a mobile terminal, such as a smart phone, that sends and receives network data traffic flows from one or more sources. For example, the endpoint 100 may receive a Wi-Fi flow 102 from a Wi-Fi network 104 (e.g., a web page) and a cellular flow 106 from a cellular network 108 (e.g. a phone call).

A user profile module 110 may be located at the endpoint 100. The user profile module 110 may be configured to maintain a user profile associated with the endpoint 100 or mobile terminal that defines one or more actions or criteria to be applied to a data packet. A deep packet inspection module 112 may also be located at the endpoint 100. The DPI module 112 may be configured to examine a data portion of data packets (e.g., received in the Wi-Fi and cellular flows 102 and 106) and perform an action related to the data packet based on the examined data portion and the user profile.

FIG. 1 illustrates an example configuration suitable for performing analytics/reporting with DPI in the endpoint device 100. According to one aspect, the user profile may include specific HTTP headers to identify the device, capture content, and report back to the server. The user profile may also provide a user identification with each HTTP transaction that includes the header.

DPI configuration may be managed from the server 114 through the use of one or more policies, or managed and controlled by the end user, or through a combination thereof.

According to another aspect, the DPI module 112 may be configured to reassemble network traffic packets into constituting objects, decoding and/or decompressing the objects as required, and inspecting the objects at one or more of seven OSI ISO layers. For example, deep packet inspection may include computer network packet filtering that examines the data part (and possibly also the header) of a packet as it passes an inspection point, in this case DPI module 112 located at endpoint 100, searching for things such as protocol non-compliance, viruses, spam, intrusions, or other defined criteria. The DPI module 112 may decide whether an action is to be taken on the packet, such as determining whether the packet may pass the inspection point or whether the packet needs to be routed to a different destination, or, for the purpose of collecting statistical information. DPI contrasts with the “shallow inspection” performed by routers and other network equipment which only need to use the first of multiple headers for IP packets (the IP header) for normal operation.

DPI module 112 may be used for lawful intercept. Lawful interception (LI) may include obtaining communications network data pursuant to lawful authority for the purpose of analysis or evidence. Such data generally consist of signaling or network management information or, in fewer instances, the content of the communications and is generally obtained in real-time.

DPI module 112 may also be used for policy definition and enforcement. Service providers may be obligated by the service-level agreement with their customers to provide a certain level of service and at the same time, enforce an acceptable use policy. These service providers may use of DPI to implement policies that cover copyright infringements, illegal materials, and unfair use of bandwidth. Policies can be defined that allow or disallow connection to or from an IP address, certain protocols, or even heuristics that identify a certain application or behavior.

DPI module 112 may also be used for targeted advertising. Network operators can use DPI-based targeted advertising to increase revenue from mobile advertising by using subscriber and network intelligence to better target and personalize ads. Working with advertising networks, advertisers, and content providers, operators can reach target audiences across network types and various end user devices. The effectiveness of the DPI-based targeted advertising may be measured by higher click-through rates for mobile ad campaigns.

According to another aspect, the DPI module 112 may be configured to use a specific HTTP header in the user profile to identify the endpoint. Alternatively or additionally, the DPI module 112 capturing the content of the data packet, and providing a user identification to a server with each HTTP transaction that includes the HTTP header.

According to another aspect, the DPI module 112 may be configured to perform at least one of: reporting, optimization, lawful intercept, targeted advertisements, quality of experience management, providing tiered services, and copyright enforcement.

The DPI may be used for actions related to reporting, optimization, lawful intercept, targeted advertisements, managing quality of experience, tiered services and copyright enforcement. While these actions may be provided by conventional DPI systems, the present disclosure provides these actions at a more granular level with optional end user control and visibility to the process, and without the high signaling/processing overhead associated with conventional systems. Screen displays are described in greater detail below for viewing and/or performing actions related to reporting, optimization, lawful intercept, targeted advertisements, managing quality of experience, tiered services and copyright enforcement at various levels of granularity.

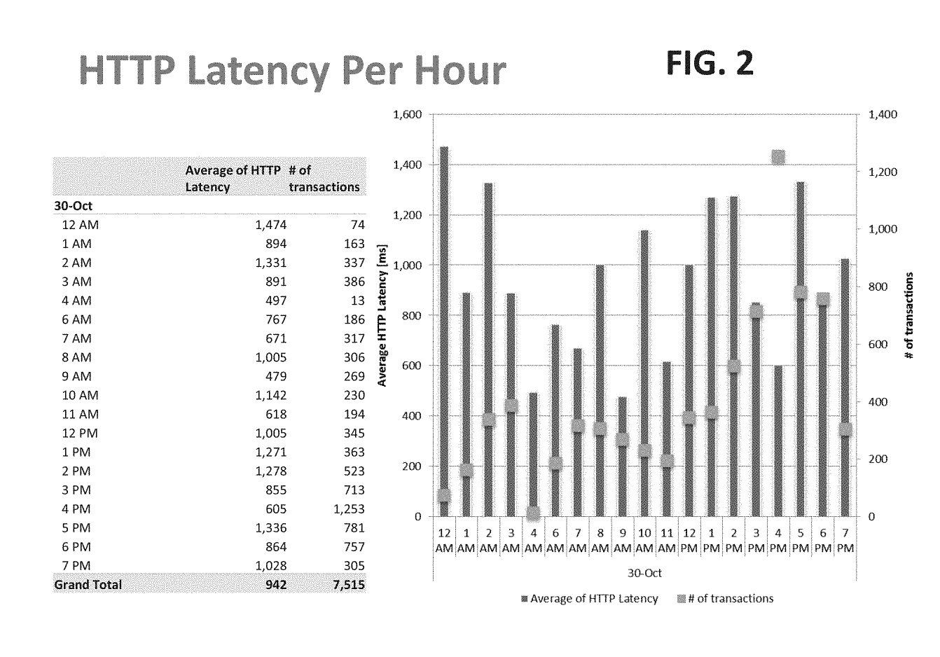

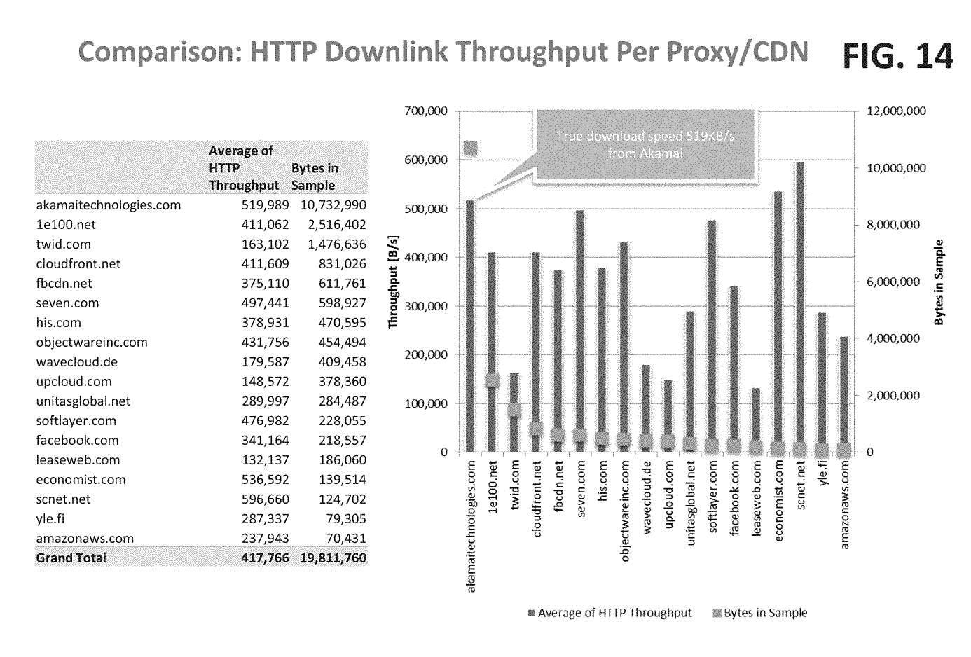

FIGS. 2-17 include network performance comparisons for an example data set according to an aspect of the subject matter described herein. FIGS. 2-13 illustrate various network performance comparisons related to HTTP latency. FIGS. 14-17 illustrate other network performance comparisons. In the illustrative examples shown in FIGS. 2-17, the response-header based data collection was configured to identify “Server” headers from the responses. It may be appreciated, however, that any response header field can be configured for data collection without departing from the scope of the subject matter described herein. The data shown represents 20 hours of day-to-day use of a Galaxy S4 device in an AT&T LTE network. The results are intended to be exemplary and not necessarily statistically relevant. While a small sample is used for the sake of illustration, it may be appreciated that the same level of granularity may be available for larger samples as well. Finally, while various comparison dimensions are presented with the example HTTP Latency metric, additional dimensions are available for other metrics as well.

The present disclosure provides for collecting data from a mobile device (i.e., endpoint) and allowing comparison of performance as an end user sees it. As shown in FIGS. 2-17, performance comparisons may include: HTTP Latency, HTTP Throughput, DNS Response Time, SSL Handshake Duration, and Application Timeouts. Performance metrics may be collected for each transaction, allowing competitive comparisons across various dimensions, or any combination of dimensions. Example dimensions may include: Time, Content owners (based on original IP destinations), CDNs (based on proxy IP destinations, or content in response headers), Applications, Content type, Protocols (e.g., HTTP, HTTPS, DNS), Carriers, Network technology, and Cell sites.

FIG. 2 is a table and bar chart showing exemplary HTTP latency data when performing DPI at an endpoint according to an embodiment of the subject matter described herein. Referring to FIG. 2, sample data is shown for each hour over an eighteen hour period. For each one hour time period, a number of transactions and an average HTTP latency may be determined. Over the eighteen hour period, the total number of transactions is 7,515 with an average HTTP latency of 942 ms. This data is graphed in the right side of FIG. 2. It may be appreciated from FIG. 2 that there is not a direct link between latency and number of transactions because latency may be affected by additional factors. For example, the 12 am time period includes high latency but few transactions while the 4 pm time period includes low latency for a large number of transactions.

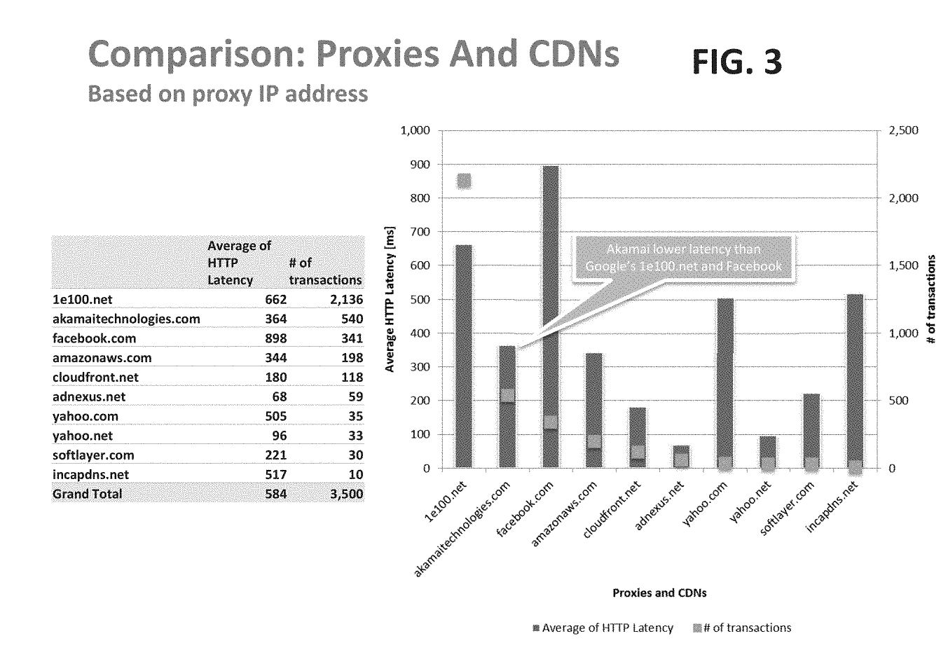

FIG. 3 is a table and bar chart showing exemplary HTTP latency comparison data between proxies and CDNs based on proxy IP address when performing DPI at an endpoint according to an embodiment of the subject matter described herein. Referring to FIG. 3, sample data is shown for ten example domains (e.g., Akamai, Yahoo, etc.). The average latency and number of transactions is listed and graphed for each domain. As shown in FIG. 3, Akamai displays a lower latency, 364 ms, than Google and Facebook (662 ms and 898 ms, respectively) for 540 transactions compared with Google and Facebook's 2,136 and 341 transactions, respectively.

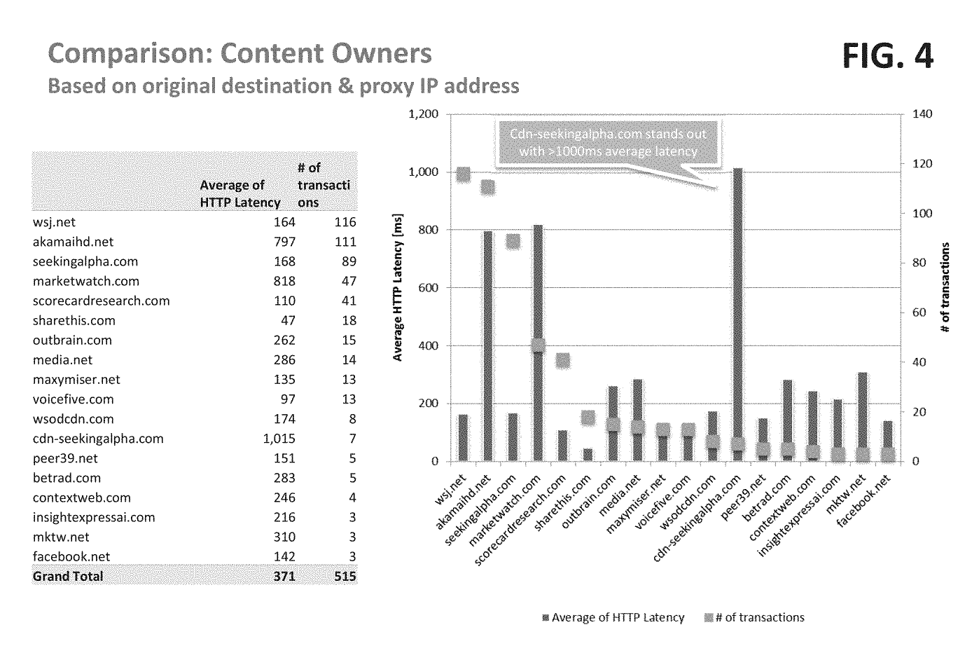

FIG. 4 is a table and bar chart showing exemplary HTTP latency comparison data for content owners based on original destination and proxy IP address when performing DPI at an endpoint according to an embodiment of the subject matter described herein. Referring to FIG. 4, the average latency and number of transactions is shown for a sample group of domains. It may be appreciated that some routes between an original destination and a proxy IP address may demonstrate relatively high, or low, average HTTP latencies. For example, cdn-seekingalpha.com demonstrates the highest measured latency of 1,015 ms yet has one of the lowest number of transactions at 7.

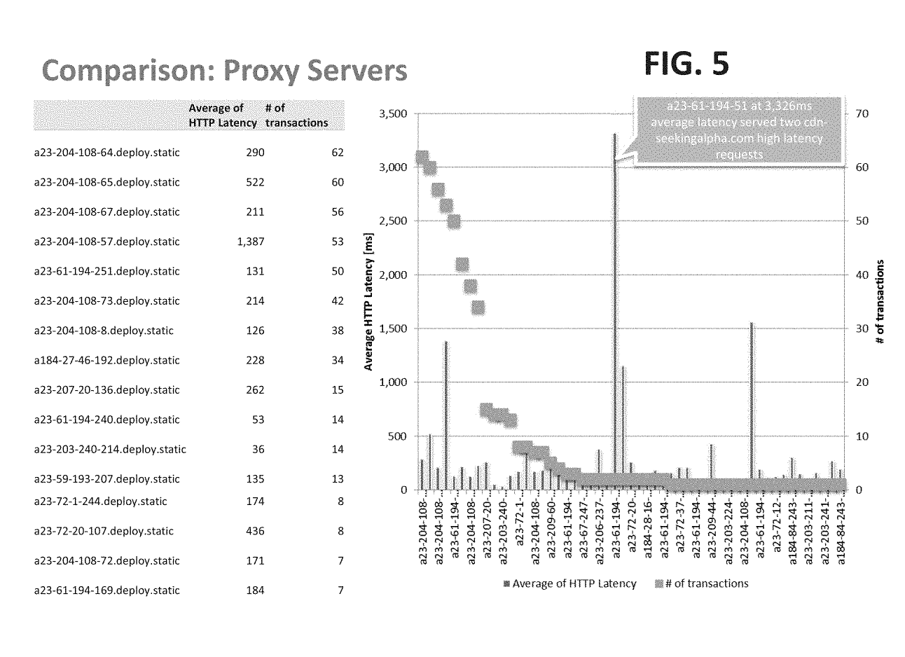

FIG. 5 is a table and bar chart showing exemplary HTTP latency comparison data for different proxy servers when performing DPI at an endpoint according to an embodiment of the subject matter described herein. Referring to FIG. 5, the average latency and number of transactions is shown for a sample group of proxy servers. This data is graphed on the right side of FIG. 5, where it may be appreciated that proxy server a23-61-194-51 demonstrates the highest latency at 3,326 ms when served with two cdn-seekingalpha.com high latency requests.

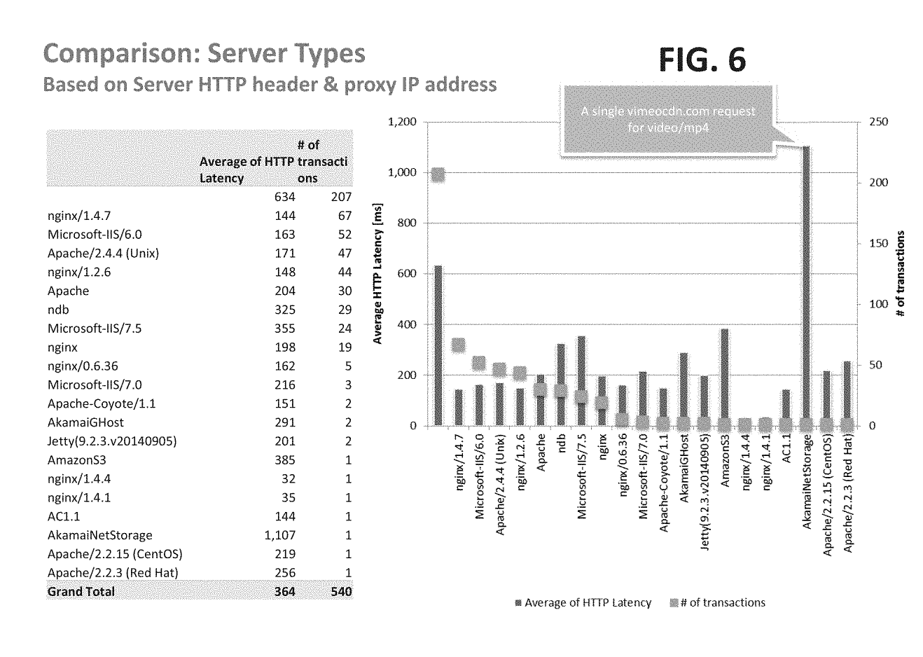

FIG. 6 is a table and bar chart showing exemplary HTTP latency comparison data for different server types based on the Server HTTP header and proxy IP address when performing DPI at an endpoint according to an embodiment of the subject matter described herein. Referring to FIG. 6, sample data is shown and graphed for various server types such as Microsoft IIS, Apache, and Amazon S3. It may be appreciated from FIG. 6 that a single vimeocdn.com request for an mp4 formatted video demonstrated the highest latency at 1,107 ms from an AkamaiNetStorage server.

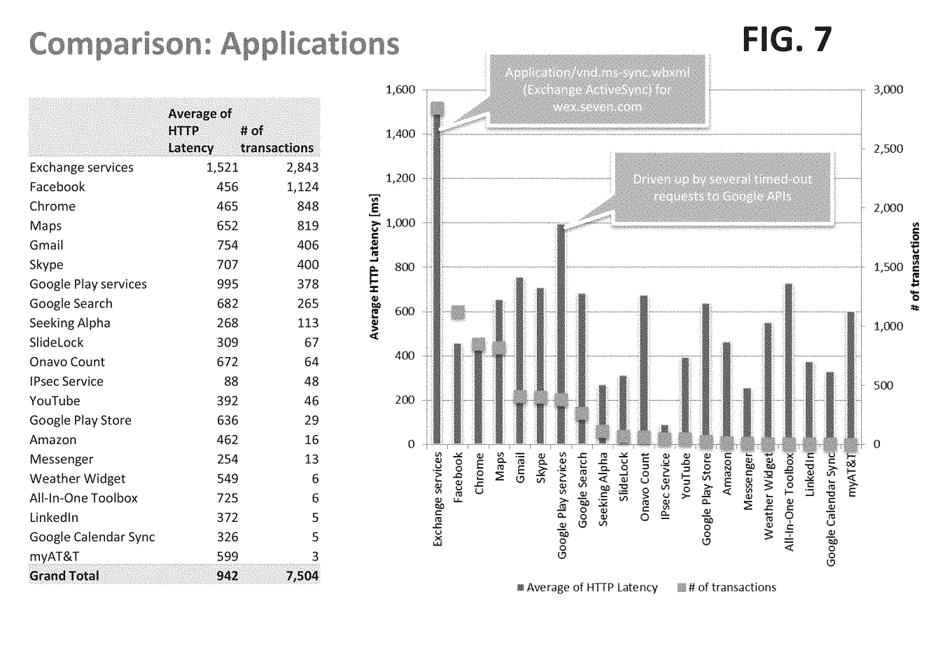

FIG. 7 is a table and bar chart showing exemplary HTTP latency comparison data for different applications when performing DPI at an endpoint according to an embodiment of the subject matter described herein. Referring to FIG. 7, sample latency and transaction data is shown and graphed for different types of application. It may be appreciated from FIG. 7 that the applications handling the largest number of transactions include Exchange services, Facebook, and various Google services (e.g., Chrome, Maps, Gmail, etc.). Additionally, it may be appreciated that Exchange services have the highest average latency at 1,521 ms, which is nearly double the overall average latency for the applications shown of 942 ms. The second highest latency is demonstrated by Google Play services, however, this value is driven up by several timed-out requests to Google APIs.

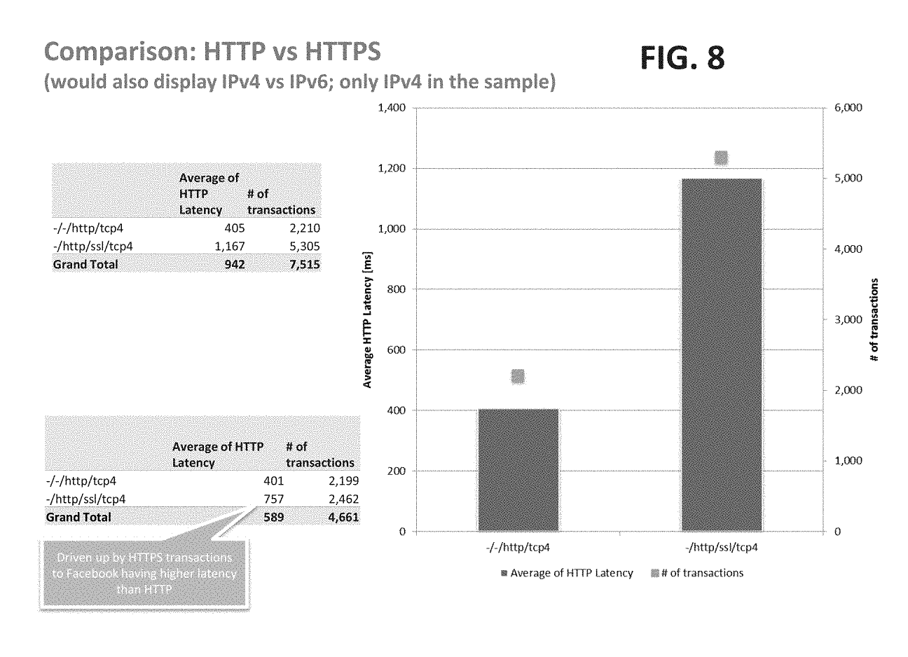

FIG. 8 is a table and bar chart showing exemplary latency comparison data between HTTP and HTTPS for IPv4 when performing DPI at an endpoint according to an embodiment of the subject matter described herein. Referring to FIG. 8, sample latency and transaction data is shown for secure (HTTPS) and insecure (HTTP) web traffic. It may be appreciated from FIG. 8 that HTTPS demonstrates a higher average latency than HTTP (e.g., 1,167 ms vs. 405 ms). However, the average latency of HTTPS drops to 757 ms if high latency HTTPS transactions from Exchange are excluded. Furthermore, the 757 ms latency is driven up by Facebook transactions which are exclusively HTTPS and generally have higher latency than HTTP.

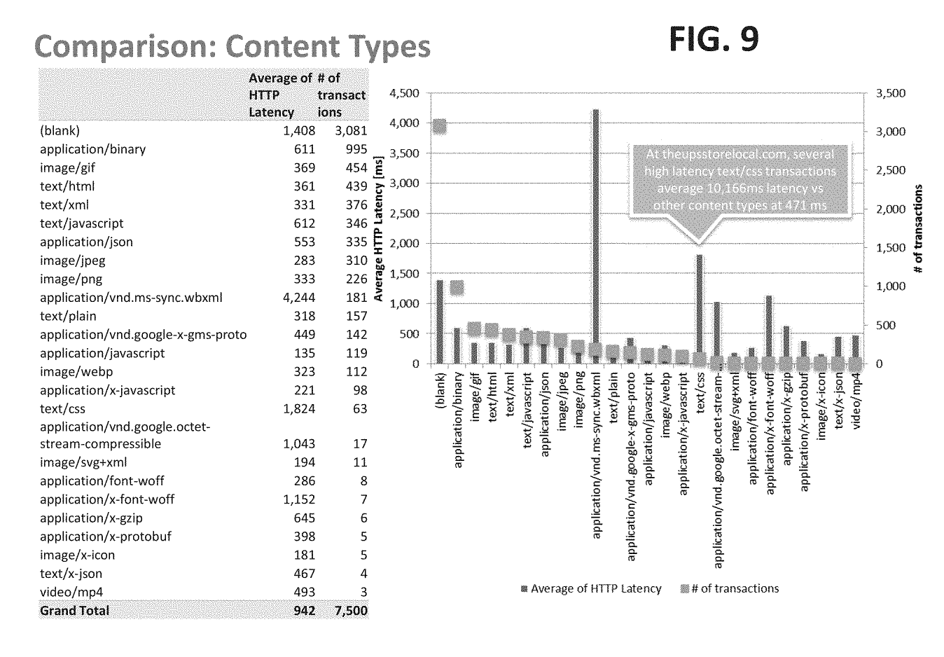

FIG. 9 is a table and bar chart showing exemplary HTTP latency comparison data for different content types when performing DPI at an endpoint according to an embodiment of the subject matter described herein. Referring to FIG. 9, sample latency and transaction data is shown and graphed for different content types such as applications, images, html text, xml text, etc. The average latency of all sampled content types is 942 ms over a total of 7,500 transactions. The highest latency is associated with application/vnd.ms-sync.wbxml at nearly four times the over average latency. It is further appreciated that the css text latency of 1,824 ms is driven up due to several very high latency transactions to a specific domain (theupsstorelocal.com) which averaged 10,166 ms. If these transactions are excluded, the remaining css text transactions demonstrate a significantly lower latency of 471 ms.

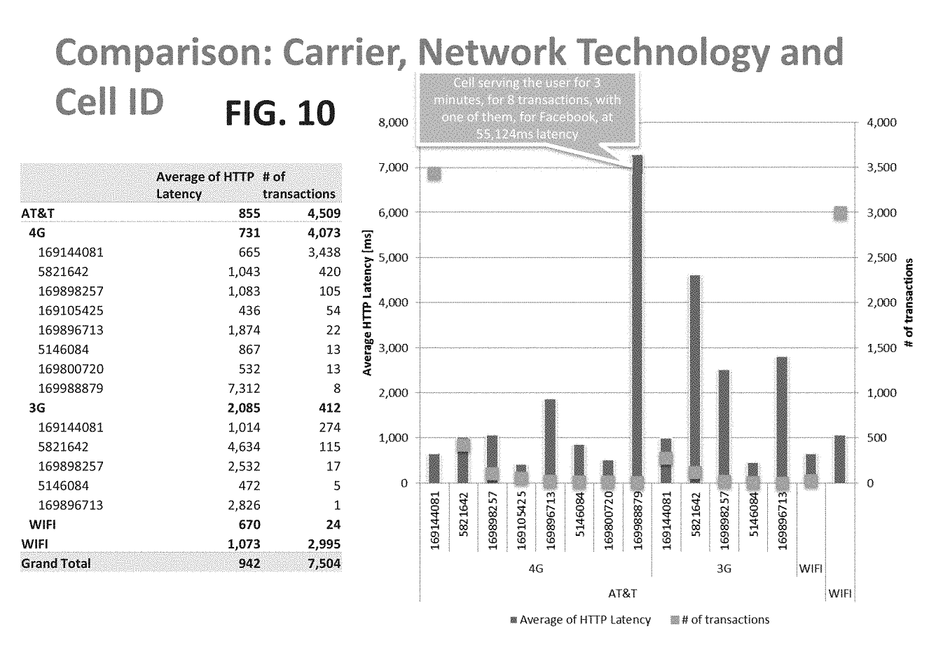

FIG. 10 is a table and bar chart showing exemplary HTTP latency comparison data for different carriers, network technologies, and cell IDs when performing DPI at an endpoint according to an embodiment of the subject matter described herein. Referring to FIG. 10, sample latency and transaction data is shown and graphed for different carriers, network technologies, and cell IDs. For example, AT&T is the carrier shown in FIG. 10, where the average latency is 731 ms over 4G networks, 2,085 ms over 3G, and 670 ms over WiFi. It may be appreciated that cell ID 169988879 had the highest average latency at 7,312 ms, however, this was because this cell served a user for three minutes which included eight transactions and one of these transactions was to Facebook.com with an extraordinarily high latency of 66,124 ms.

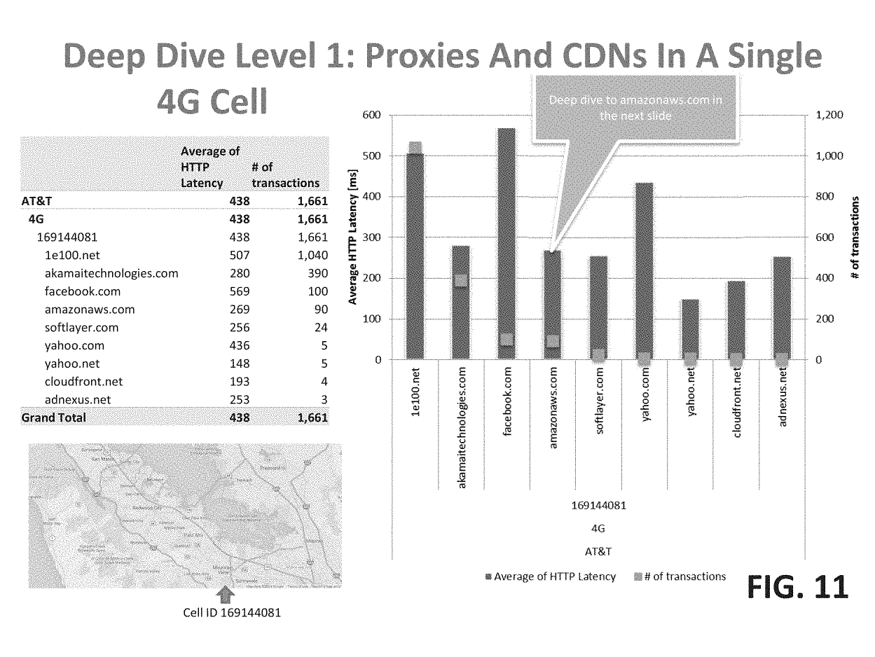

FIG. 11 is a table, bar chart, and map showing exemplary HTTP latency comparison data at a first level of granularity for proxies and CDNs in a single cell when performing DPI at an endpoint according to an embodiment of the subject matter described herein. Referring to FIG. 11, sample latency and transaction data is shown and graphed for a single AT&T 4G cell (i.e., cell ID 169144081). It may be appreciated that the third highest latency and the largest number of transaction in this cell are associated with Google (i.e., 1e100.net). In addition to the geographic location of the cell being displayed on a map in the lower left portion of the display, a second level of granularity may be displayed by clicking on one of the bars in the chart on the right hand side of the display. For example, if a user wishes to view data for Amazonaws.com in greater detail, they can click on the Amazonaws.com element and a second level of granularity may be displayed.

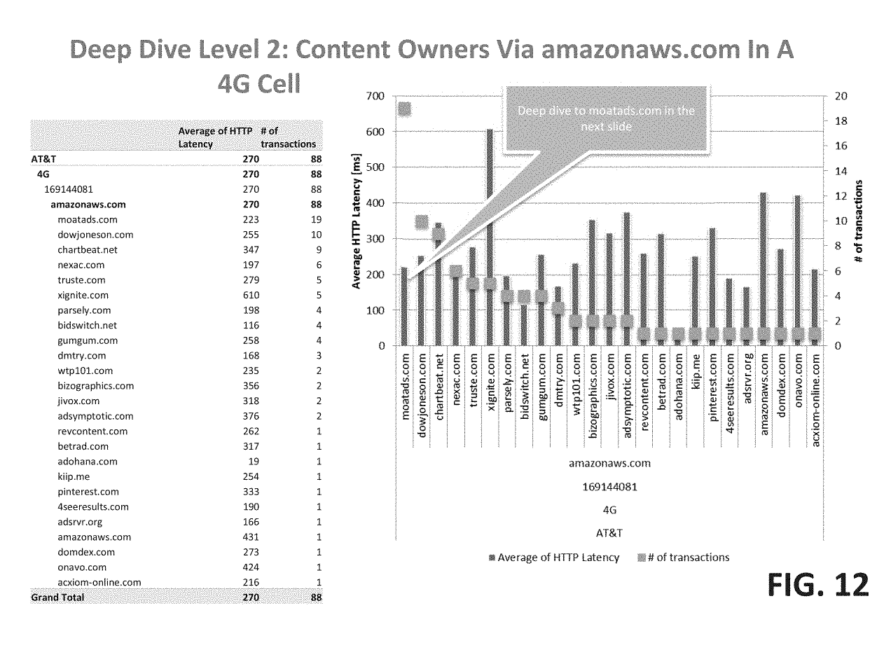

FIG. 12 is a table and bar chart showing exemplary HTTP latency comparison data at a second level of granularity for content owners in a single cell when performing DPI at an endpoint according to an embodiment of the subject matter described herein. Referring to FIG. 12, content owners via Amazonaws.com in the single AT&T 4G cell shown in FIG. 11 include content owners such as moatads.com, dowjoneson.com, and chartbeat.com. It may be appreciated that the average latency of moatads.com is 223 ms over 19 transactions and that further detail can be obtained by clicking on the moatads.com element displayed.

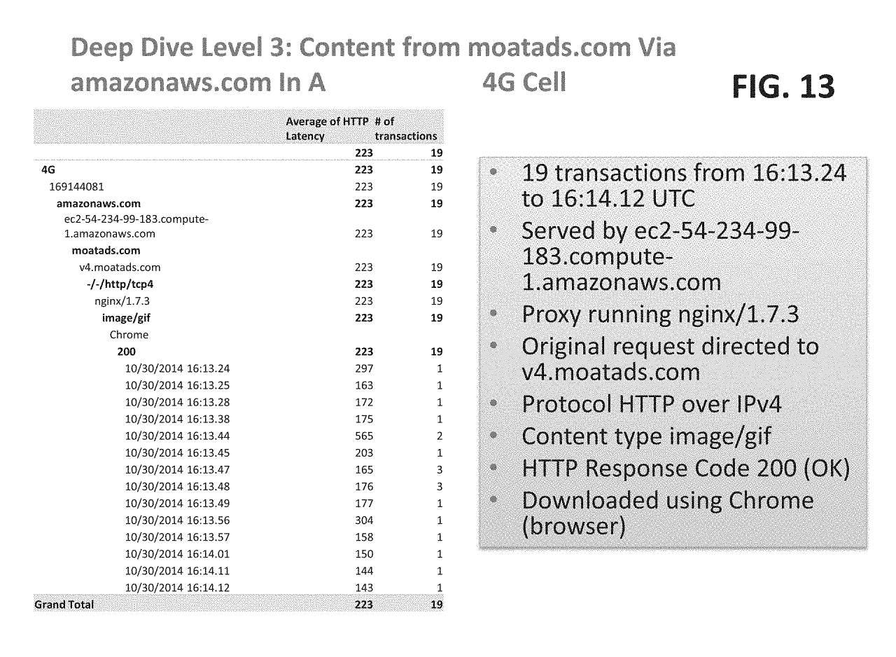

FIG. 13 is a table showing exemplary HTTP latency comparison data at a third level of granularity for content in a single cell when performing DPI at an endpoint according to an embodiment of the subject matter described herein. Referring to FIG. 13, additional detail is shown for moatads.com which may be arrived at by clicking through from the display shown in FIG. 12. The content from moatads.com via Amazonaws.com in the single AT&T 4G cell shown in FIG. 11 includes an average latency of 223 ms over the 19 transactions. Each of the individual 19 transactions are shown, along with a timestamp, protocol, content type, browser, and other relevant data.

Thus, by displaying nested views of increasing granularity, as shown in FIGS. 11-13, the present invention provides a natural way for users to obtain relevant network information in as much detail as is desired. By locating a deep packet inspection module in an endpoint rather, it can examine a data portion of the data packet and to perform an action related to the data packet based on the examined data portion and the user profile. Performing DPI at the endpoint rather than at a network router or switch allows for capturing full coverage of the user's actions because it captures data at the only point in the network through which all of the user's data goes through (i.e., the endpoint). Thus, the present disclosure provides DPI-based actions, management, and reporting desired by network operators while avoiding the limitations associated with conventional DPI.

FIG. 14 is a table and bar chart showing exemplary HTTP throughput data for HTTP downlink throughput per proxy/CDN when performing DPI at an endpoint according to an embodiment of the subject matter described herein. Referring to FIG. 14, sample downlink throughput is shown for various proxies/CDNs such as Akamai, Google, and Facebook. The average HTTP throughput for the sampled proxies/CDNs is 417,766 Bytes per second measured over a total of 19,811,760 Bytes. It may be appreciated that the lowest download speed is associated with leaseweb.com while the highest download speed is associated with economist.com.

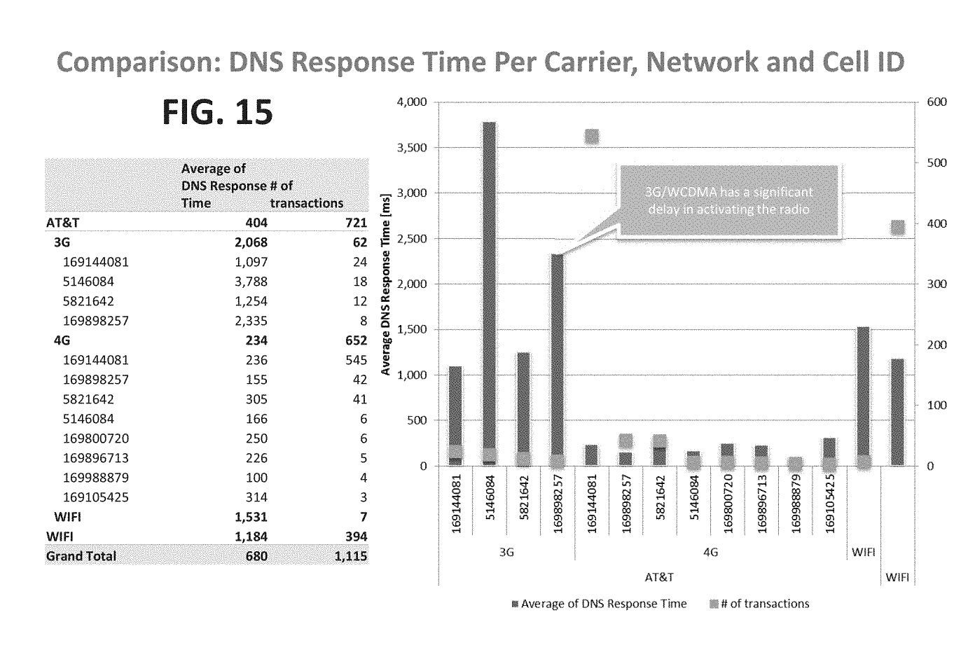

FIG. 15 is a table and bar chart showing exemplary DNS response time data per carrier, network, and cell ID when performing DPI at an endpoint according to an embodiment of the subject matter described herein. Referring to FIG. 15, sample DNS response time data is shown and graphed for various carriers, network technologies, and Cell IDs. For example, AT&T has an average DNS response time of 404 ms over 721 transactions, with 3G networks demonstrating the slowest DNS response time and 4G networks demonstrating the fastest DNS response time. This difference may be due to the longer delay associated with activating the endpoint's 3G/WCDMA radio.

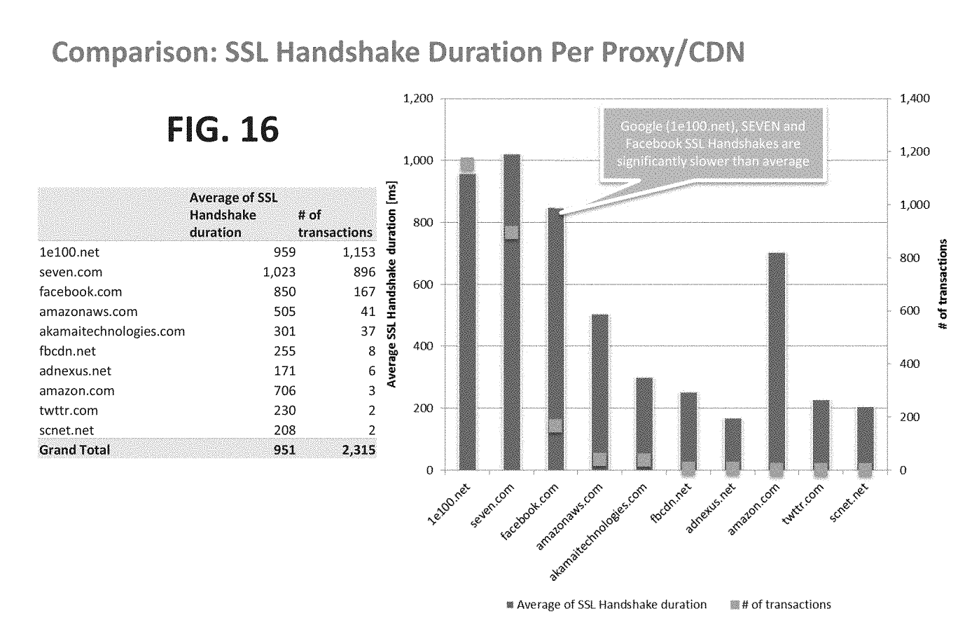

FIG. 16 is a table and bar chart showing exemplary SSL handshake duration data per proxy/CDN when performing DPI at an endpoint according to an embodiment of the subject matter described herein. Referring to FIG. 16, sample SSL handshake duration and transaction data is shown and graphed for various proxies/CDNs. The average SSL handshake duration is 951 ms over 2,315 transactions, with seven.com demonstrating the slowest average SSL handshake duration of 1,023 ms and adnexus.net demonstrating the fastest average SSL handshake duration of 171 ms. As shown in the graph portion on the right side of the display, Google, Seven, and Facebook SSL handshakes are significantly slower than average.

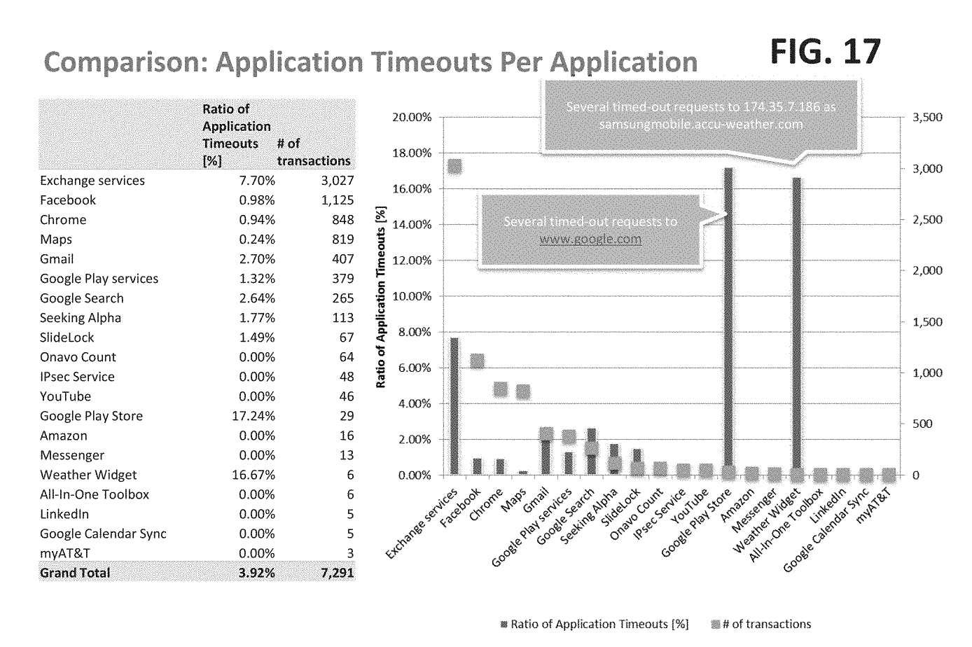

FIG. 17 is a table and bar chart showing exemplary application timeouts data per application when performing DPI at an endpoint according to an embodiment of the subject matter described herein. Referring to FIG. 17, sample application timeout data is shown and graphed for various applications. The average ration of application timeouts is 3.92% over 7,291 transactions. From the graph it may be appreciated that the Google Play Store and Weather Widget applications have significantly larger than average ratios of application timeouts (e.g., 16-18%). This is due to several timed-out requests to the Google homepage (www.google.com) and samsungmobile.accu-weather.com, respectively.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
at an inspection point located at an endpoint or mobile terminal of a communications network:
examining a data portion of a data packet;
providing a user profile associated with the endpoint or mobile terminal that defines one or more actions or criteria to be applied to the data packet; and
performing an action related to the data packet based on the examined data portion and the user profile.

2. The method of claim 1, wherein examining a data portion of a data packet includes reassembling network traffic packets into constituting objects, decoding and/or decompressing the objects as required, and inspecting the objects at one or more of seven Open Systems Interconnection (OSI) International Organization for Standardization (ISO) layers.

3. The method of claim 1, wherein performing an action includes at least one of: using a specific hypertext transfer protocol (HTTP) header in the user profile to identify the endpoint, capturing the content of the data packet, and providing a user identification to a server with each HTTP transaction that includes the HTTP header.

4. The method of claim 1, wherein performing an action includes at least one of: reporting, optimization, lawful intercept, targeted advertisements, quality of experience management, providing tiered services, and copyright enforcement.

5. The method of claim 1, further comprising managing the user profile from a server through policies.

6. The method of claim 1, further comprising managing the user profile at the endpoint by an end user.

7. The method of claim 1, wherein the endpoint includes one of: a user equipment, mobile communications terminal, smartphone, or tablet.

8. The method of claim 1, wherein performing an action related to the data packet includes determining whether the data packet is associated with protocol non-compliance, viruses, spam, intrusions, or other pre-defined criteria.

9. The method of claim 1, further comprising collecting performance data from the endpoint.

10. The method of claim 1, wherein the collected performance data includes one or more of: HTTP Latency, HTTP Throughput, DNS Response Time, SSL Handshake Duration, and Application Timeouts.
